(19) United States
(12) Patent Application Publication
(10) Pub. No.: US 2022/0320776 A1
(43) Pub. Date: Oct. 6, 2022

(54) CONNECTOR STRUCTURE

(71) Applicant: JESS-LINK PRODUCTS CO., LTD., New Taipei City (TW)

(72) Inventor: Yun-Chang YANG, New Taipei City (TW)

(21) Appl. No.: 17/223,797

(22) Filed: Apr. 6, 2021

(51) Int. Cl. H01R 13/03; H01R 24/60; H01R 13/6461

(52) U.S. Cl. CPC H01R 13/03; H01R 24/60; H01R 13/6461

(57) ABSTRACT

A connector structure includes an insulating case, a terminal set and a grounding component. The terminal set is configured in the insulating case. The terminal set further includes a first terminal set, and the first terminal set includes a plurality of signal terminals and a plurality of grounding terminals. The grounding component is configured in the insulating case. The grounding component includes a component body and a graphene layer configured on a surface of the component body. The first grounding terminals are connected in series by contacting the graphene layer.

### BACKGROUND OF THE INVENTION

### 1. Field of the Invention

The present invention relates to a connector structure, and more particularly, to a connector structure that can maintain the grounded shield effect and reduce cost.

### 2. Description of the Prior Art

Connectors are connecting components and accessories for electrical signals, and the electronic devices translate and transmit the signal to each other through the cables and connectors. That is to say, the connectors are the communicating bridges for the signals. The connectors are widely applied to cars and computer peripheral and communicating data applications, industries, military and aerospace industry, transportation, consumer electronics, medical treatments, instruments, commercial equipment and so on. Therefore, the connectors play an important role in many fields.

However, along with the development of the electronics industry, the tendency is to miniaturize the electronic products; therefore, the distance among the electronic components in the circuit board of the electronic product is getting smaller. Since the reduction of the distance between the conductive terminals is not conducive to the transmission of high-frequency signals, it is easy to cause crosstalk between the conductive terminals, thereby affecting the signal transmission characteristics of the connectors.

In general, the connector includes a grounding component connected to the grounding terminals to reduce the influence of electromagnetic interference or crosstalk. Furthermore, the grounding component is arranged in the connector in the form of a sheet shape and contacts the grounding terminals to connect the grounding terminals in series, thereby forming the grounded shield. Moreover, the grounding component may be provided in the connector in the form of a block when the connector has a design requirement. However, the material of the grounding component is usually metal. Therefore, the weight of the ground component will be increased when the shape of the ground component needs to be a block shape, thereby increasing the weight of the connector and reducing the convenience of products. In addition, the bulk metal grounding component not only has a complicated manufacturing process, but also has a relatively high manufacturing cost, thereby increasing the product costs.

### SUMMARY OF THE INVENTION

Therefore, the present invention provides a connector structure to solve the problems of the prior art.

In one embodiment of the present invention, the connector structure includes an insulating case, a terminal set and a grounding component. The terminal set is configured in the insulating case. The terminal set further includes a first terminal set, and the first terminal set includes a plurality of first grounding terminals. The grounding component is configured in the insulating case. The grounding component includes a component body formed of a graphene material and a non-conductive material. The first grounding terminals are connected in series by contacting the grounding component.

Wherein, the graphene material forms a graphene layer configured on a surface of the component body by coating.

Wherein, the shape of the grounding component is selected from one of the sheet, rectangular and U shapes.

Wherein, the grounding component further includes a plurality of protruding structures extending from the surface of the component body. The graphene layer is configured on the surface and the protruding structures, and the first grounding terminals are connected in series by contacting the protruding structures.

Wherein, the arrangement of the protruding structures is corresponding to that of the first grounding terminals.

Wherein, the shapes of the protruding structures are selected from one of the rectangular shapes, I-shapes and arc shapes.

Wherein, the first grounding terminals have a bulge portion respectively. The bulge portion contacts the graphene layer of the grounding component to connect the first grounding terminals in series.

Wherein, the terminal set further includes a second terminal set. The second terminal set includes a plurality of second grounding terminals. The second grounding terminals contact the graphene layer to connect the first grounding terminals and the second grounding terminals in series.

Wherein, the grounding component is configured between the first terminal set and the second terminal set, and the component body further includes a first surface, a second surface and a third surface. The third surface is adjacent to the first surface and the second surface, and the graphene layer is configured on the first surface, second surface and the third surface. The first grounding terminals and the second grounding terminals are contacted to the graphene layer of the first surface and the second surface respectively and connected in series through the graphene layer of the third surface.

Furthermore, the grounding component further includes a plurality of first protruding structures extending from the first surface of the component body and a plurality of second protruding structures extending from the second surface of the component body. The graphene layer is configured on the first protruding structures and the second protruding structures. The first grounding terminals and the second grounding terminals are connected in series by contacting the first protruding structures and the second protruding structures respectively.

In one embodiment, the non-conductive material and the graphene material form the component body by injection molding.

Wherein, the grounding component further includes a plurality of third protruding structures extending from a first surface of the component body. The first grounding terminals are connected in series by contacting the third protruding structures.

Wherein, the first grounding terminals have a bulge portion respectively. The bulge portion contacts the component body to connect the first grounding terminals in series.

Wherein, the terminal set further includes a second terminal set. The second terminal set comprises a plurality of second grounding terminals. The second grounding terminals contact the component body to connect the first grounding terminals and the second grounding terminals in series.

Furthermore, the grounding component further includes a plurality of fourth protruding structures extending from the second surface of the component body. The second surface is opposite to the first surface. The first grounding terminals and the second grounding terminals are connected in series by contacting the third protruding structures and the fourth protruding structures respectively.

In summary, the connector structure of the present invention can connect the grounding terminals of the terminal set in series according to the graphene layer configured on the grounding component to form the grounded shield effect. In addition, the connector structure can reduce the weight of the connector by the non-conductive component body, thereby increasing the convenience and reducing the costs of products.

### BRIEF DESCRIPTION OF THE APPENDED DRAWINGS

FIG. 1 is an exploded diagram illustrating a connector structure according to an embodiment of the present invention.

FIG. 2 is a schematic diagram illustrating the assembly of the first grounding terminal and the grounding component in FIG. 1.

FIG. 3 is a schematic diagram illustrating the assembly of the first grounding terminal and the grounding component according to an embodiment of the present invention.

FIG. 4 is an exploded diagram illustrating the connector structure according to an embodiment of the present invention.

FIG. 5 is a schematic diagram illustrating the assembly of the first grounding terminal, the second grounding terminal and the grounding component in FIG. 4.

FIG. 6 is a schematic diagram illustrating the terminal set and the grounding component according to an embodiment of the present invention.

FIG. 7A to FIG. 7C are schematic diagrams illustrating the grounding component according to the different embodiments of the present invention.

FIG. 8 is an exploded diagram illustrating the connector structure according to an embodiment of the present invention.

FIG. 9 is a schematic diagram illustrating the assembly of the first grounding terminal, the second grounding terminal and the grounding component in FIG. 8.

FIG. 10 is a schematic diagram illustrating the assembly of the first grounding terminal, the second grounding terminal and the grounding component according to an embodiment of the present invention.

### DETAILED DESCRIPTION OF THE INVENTION

For the sake of the advantages, spirits and features of the present invention can be understood more easily and clearly, the detailed descriptions and discussions will be made later by way of the embodiments and with reference of the diagrams. It is worth noting that these embodiments are merely representative embodiments of the present invention, wherein the specific methods, devices, conditions, materials and the like are not limited to the embodiments of the present invention or corresponding embodiments. Moreover, the devices in the figures are only used to express their corresponding positions and are not drawing according to their actual proportion.

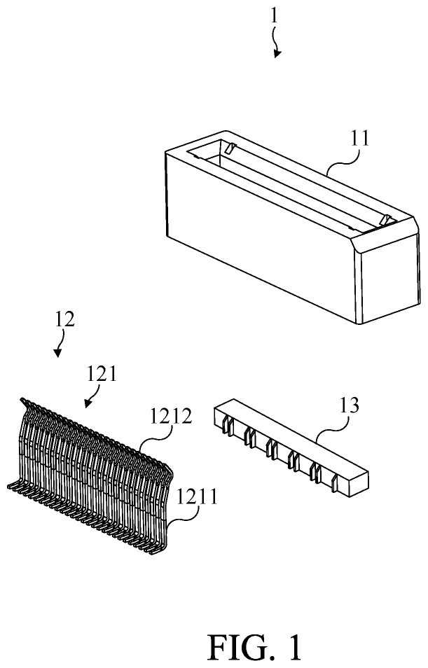

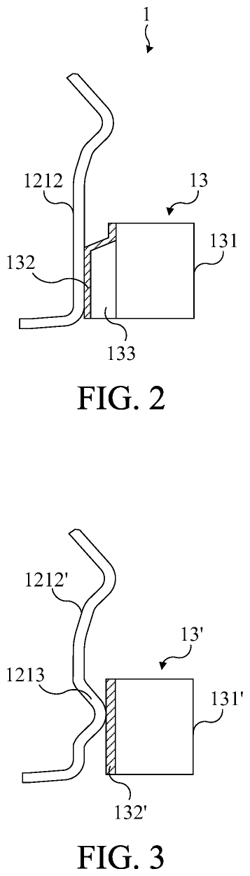

Please refer to FIG. 1 and FIG. 2. FIG. 1 is an exploded diagram illustrating a connector structure 1 according to an embodiment of the present invention. FIG. 2 is a schematic diagram illustrating the assembly of the first grounding terminal 1212 and the grounding component 13 in FIG. 1. As shown in FIG. 1 and FIG. 2, the connector structure 1 includes an insulating case 11, a terminal set 12 and a grounding component 13. The terminal set 12 is configured in the insulating case 11 and includes a first terminal set 121. The first terminal set 121 includes a plurality of first signal terminals 1211 and a plurality of first grounding terminals 1212. The grounding component 13 is configured in the insulating case 11. The grounding component 13 includes a component body 131 and a graphene layer 132 configured on a surface of the component body 131. The grounding component 13 further includes a plurality of protruding structures 133 extending from the surface of the component body 131. The graphene layer 132 is continuously configured on each surface of the component body 131 and the protruding structures 133. Moreover, the arrangement of the protruding structures 133 is corresponding to that of the first grounding terminals 1212.

When the terminal set 12 and the grounding component 13 are assembled and configured in the insulating case 11, the terminal set 12 is adjacent to the grounding component 13 and the graphene layer 132 configured on the grounding component 13 contacts the surface of one side of the first terminal set 121. That is to say, the graphene layer 132 is located between the component body 131 and the terminal set 12. Furthermore, the first grounding terminals 1212 can respectively contact the graphene layer 132 configured on the surface of the corresponding protruding structures 133, so that the first grounding terminals 1212 are connected in series through the graphene layer 132 configured on the surface of the component body 131 and the surface of the protruding structures 133.

In practice, the protruding structures 133 can be integrally formed on the component body 131, but it is not limited thereto. The graphene layer 132 can be configured and covered on the surface of the component body 131 by coating or chemical deposition. Therefore, the first grounding terminals 1212 of the terminal set 12 can be corresponding to the protruding structures 133 of the grounding component 13 and contact the graphene layer 132 configured on the surface of the protruding structures 133 after the connector structure 1 is assembled, so that the first grounding terminals 1212 are connected in series. It should be noted that the graphene layer 132 not only can be disposed on one surface of the component body 131, but also can be disposed on two or more surfaces of the component body 131. Moreover, the graphene layer 132 even can be disposed on all surfaces of the component body 131.

In this embodiment, the material of the component body 131 is a non-conductive material. In practice, the material of the component body 131 can be plastic, but it is not limited thereto. The grounding component 13 can be rectangular. Because the graphene has the conductivity, the surface of the grounding component 13 covered by the graphene layer 132 also has the conductivity. Therefore, when the first grounding terminals 1212 of the terminal set 12 contact the graphene layer 132 of the grounding component 13, the graphene layer 132 connects the first grounding terminals 1212 in series to form a greater grounded shield effect. In addition, since the material of the component body 131 is a non-conductive material, the weight of the grounding component 13 is lighter than that of the grounding component with a metal material, thereby improving the convenience of products.

In general, the signal terminals and ground terminals of the terminal set 12 are arranged in parallel. Therefore, when the terminal set 12 contacts the grounding component 13, the first grounding terminals 1212 will contact the graphene layer 132 configured on the protruding structures 133 first to prevent the first signal terminals 1211 from contacting the grounding component 13, thereby avoiding short circuits occur. Moreover, when the first grounding terminals 1212 respectively contact the protruding structures 133, the graphene layer 132 disposed on the surface of the protruding structures 133 contact the first grounding terminals 1212, and the graphene layer 132 disposed on the surface of the component body 131 connects the graphene layer 132 disposed on each surface of the protruding structures 133. Therefore, the grounding component 13 connects the first grounding terminals 1212 in series through the graphene layer 132 configured on the surfaces of the component body 131 and protruding structures 133.

Please refer to FIG. 3. FIG. 3 is a schematic diagram illustrating the assembly of the first grounding terminal 1212′ and the grounding component 13′ according to an embodiment of the present invention. The difference between this embodiment and the aforementioned embodiment is that the grounding component 13′ does not include the protruding structures and the first grounding terminal 1212′ has a bulge portion 1213. Each bulge portion 1213 of the first grounding terminals 1212′ contacts the graphene layer 132′ of the grounding component 13′, so that the first grounding terminals 1212′ are connected in series through the graphene layer 132′ of the grounding component 13′. In practice, the first ground terminals 1212′ can be bent to form the bulge portion 1213, and the bulge portion 1213 protrudes toward the direction of the grounding component 13′. That is to say, the bulge portion 1213 is between the first grounding terminal 1212′ and the grounding component 13′. Therefore, when the terminal set contacts the grounding component 13′, each bulge portion 1213 of the first grounding terminals 1212′ will contact the grounding component 13′ first. Furthermore, the bulge portions 1213 of the first grounding terminals 1212′ contact the graphene layer 132′ of the component body 131′ to connect the first grounding terminals 1212′ in series.

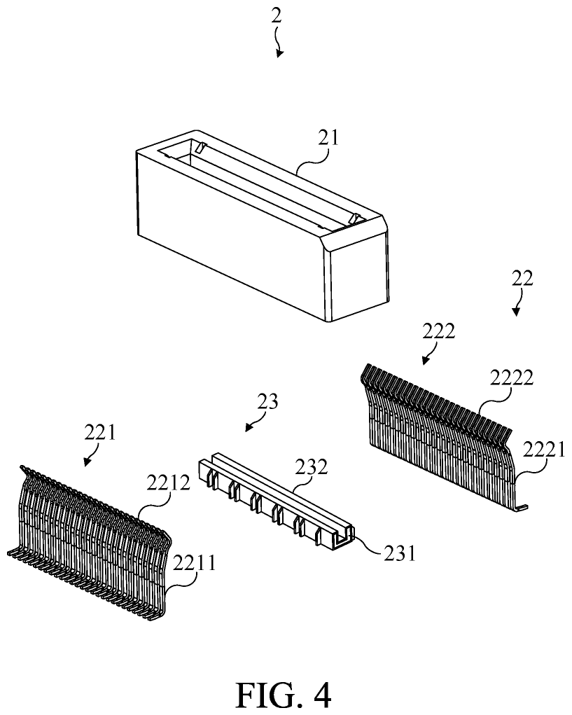

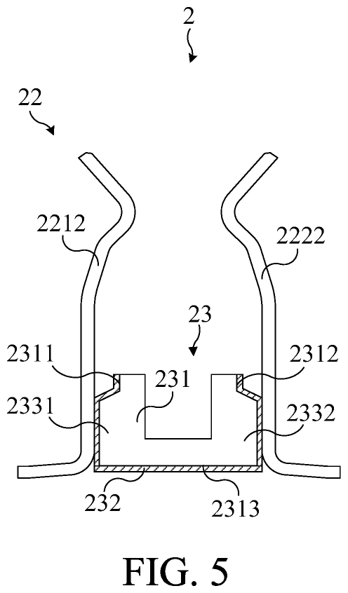

Please refer to FIG. 4 and FIG. 5. FIG. 4 is an exploded diagram illustrating the connector structure 2 according to an embodiment of the present invention. FIG. 5 is a schematic diagram illustrating the assembly of the first grounding terminal 2212, the second grounding terminal 2222 and the grounding component 23 in FIG. 4. The difference between this embodiment and the aforementioned embodiment is that the terminal set 22 of the connector structure 2 further includes a second terminal set 222, the plurality of protruding structures are arranged on the opposite sides of the grounding component 23, and the graphene layer 232 is configured on the component body 231 and the surfaces of the protruding structures. Furthermore, the protruding structures are corresponding to the first grounding terminal 2212 and the second grounding terminal 2222. As shown in FIG. 4 and FIG. 5, the second terminal set 222 includes a plurality of signal terminals 2221 and a plurality of grounding terminals 2222, and the second terminal set 222 is disposed opposite to the first terminal set 221. The grounding component 23 is disposed between the first terminal set 221 and the second terminal set 222.

In this embodiment, the shape of the grounding component 23 can be U shape. The first surface 2311 of the component body 231 faces the first terminal set 221, the second surface 2312 of the component body 231 faces the second terminal set 222, and the third surface 2313 is adjacent to the first surface 2311 and the second surface 2312. The graphene layer 232 is configured on the first surface 2311, the second surface 2312 and the third surface 2313 of the component body 231. Because the third surface 2313 is adjacent to the first surface 2311 and the second surface 2312, the graphene layer 232 configured on the third surface 2313 connects the graphene layers 232 of the first surface 2311 and the second surface 2312. When the connector structure 2 is assembled, the first grounding terminals 2212 of the first terminal set 221 are connected in series by contacting the graphene layer 232 on the first surface 2311 of the component body 231, and the second grounding terminals 2222 of the second terminal set 222 are connected in series by contacting the graphene layer 232 on the second surface 2312 of the component body 231. Furthermore, the first grounding terminals 2212 and the second grounding terminals 2222 are connected in series through the graphene layer 232 configured on the third surface 2313 of the component body 231 to form the grounded shield effect.

Moreover, the grounding component 23 further includes a plurality of first protruding structures 2331 extending from the first surface 2311 of the component body 231 and a plurality of second protruding structures 2332 extending from the second surface 2312 of the component body 231. The first grounding terminals 2212 and the second grounding terminals 2222 are connected in series by contacting the first protruding structures 2331 and the second protruding structures 2332 respectively. The functions and positions of the component body 231, graphene layer 232, the first protruding structures 2331 and the second protruding structures 2332 of the grounding component 23 of this embodiment are the same with those of components of the embodiment in FIG. 3, so it will not be described hereto. Therefore, when the connector structure 2 is assembled, the first grounding terminals 2212 are connected in series by contacting the graphene layer 232 on the first protruding structures 2331, and the second grounding terminals 2222 are connected in series by contacting the graphene layer 232 on the second protruding structures 2332. Furthermore, the first grounding terminals 2212 and the second grounding terminal 2222 can be connected in series through the graphene layer 232 on the third surface 2313 of the component body 231 to form the grounded shield effect.

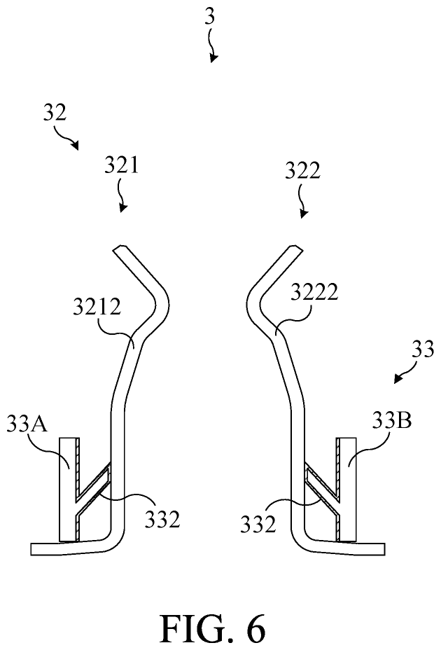

Please refer to FIG. 6. FIG. 6 is a schematic diagram illustrating the terminal set 32 and the grounding component 33 according to an embodiment of the present invention. The difference between this embodiment and the aforementioned embodiment is that the shape of the grounding component 33 is a sheet shape, and the grounding component 33 includes a first grounding component 33A and a second grounding component 33B. The first grounding component 33A and a second grounding component 33B can include protruding structures respectively, and the protruding structures are corresponding to the first grounding terminals 3212 and second grounding terminals 3222. In practice, as shown in FIG. 6, the first grounding component 33A and a second grounding component 33B are configured at the outer side of the first terminal set 321 and the second terminal set 322 respectively. That is to say, when the terminal set 32 and the grounding component 33 are assembled and configured in the insulating case, the first grounding component 33A is located between the insulating case and the first terminal set 321, and the second grounding component 33B is located between the insulating case and the second terminal set 322. The graphene layer 332 is configured on the surfaces of the first grounding component 33A and the protruding structures and located between the first grounding component 33A and the first terminal set 321. The graphene layer 332 is configured on the surfaces of the second grounding component 33B and the protruding structures and located between the second grounding component 33B and the second terminal set 322. Therefore, the first grounding terminals 3212 are corresponding to the protruding structures of the first grounding component 33A and connected in series by contacting the graphene layer 322 configured on the surface of the protruding structures, and the second grounding terminals 3222 are corresponding to the protruding structures of the second grounding component 33B and connected in series by contacting the graphene layer 322 configured on the surface of the protruding structures. In this embodiment, the functions and positions of the protruding structures are the same with those of those of components of the aforementioned embodiment, so it will not be described hereto.

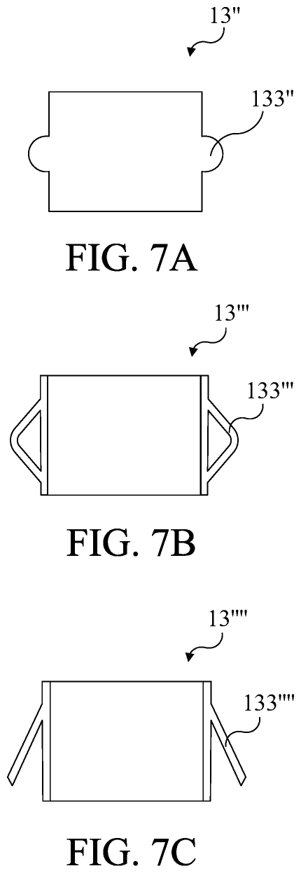

Please refer to FIG. 1, and FIG. 7A to FIG. 7C. FIG. 7A to FIG. 7C are schematic diagrams illustrating the grounding component 13″, 13′″ and 13″″ according to the different embodiments of the present invention. In addition to the fact that the shape of the protruding structure 133 of the grounding component 13 can be a rectangular shape as shown in FIG. 1 and FIG. 2, the protruding structure 133 also can be other shapes. As shown in FIG. 7A to FIG. 7C, the shapes of the protruding structure 133″, 133′″ not only can be arc shapes, the shape of the protruding structure 133″″ also can be an I shape. In practice, the protruding structure 133″, 133′″ and 133″″ can be formed by cutting or punching, but it is not limited thereto.

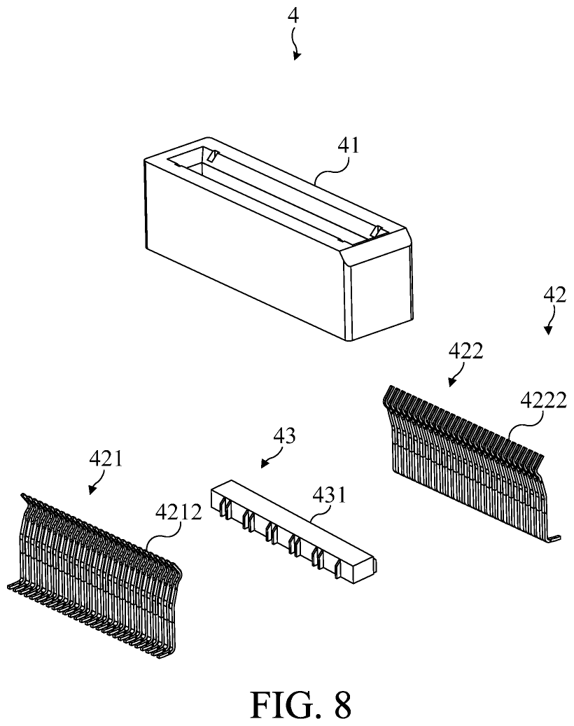

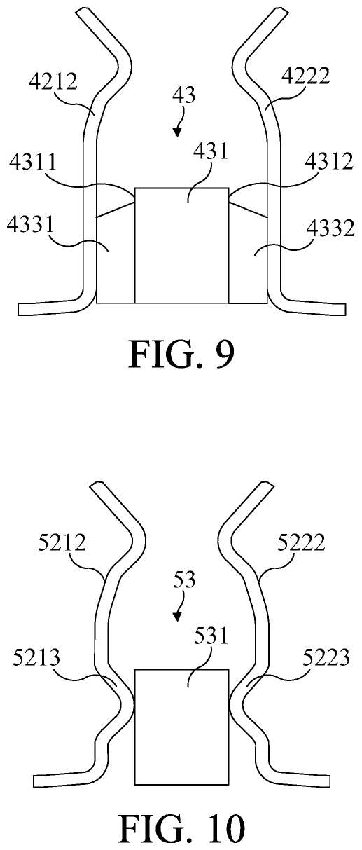

The grounding component not only can be in the form of the aforementioned embodiments, but also can be other forms. Please refer to FIG. 8 and FIG. 9. FIG. 8 is an exploded diagram illustrating the connector structure 4 according to an embodiment of the present invention. FIG. 9 is a schematic diagram illustrating the assembly of the first grounding terminal 4212, the second grounding terminal 4222 and the grounding component 43 in FIG. 8. The difference between this embodiment and the aforementioned embodiment is that the grounding component 43 includes a plastic material and a graphene material, and the plastic material and the graphene material forms the component body 431. In practice, the plastic material and the graphene material can be plastic colloid and graphene colloid, and the component body 431 can be formed by injection molding. Therefore, the component body 431 has conductivity, and the first grounding terminal 4212 of the first terminal set 421 and the second grounding terminal 4222 of the second terminal set 422 can be connected in series by contacting the component body 431.

Moreover, as shown in FIG. 8 and FIG. 9, the component body 431 may include a first surface 4311 and a second surface 4312, and the first surface 4311 is opposite to the second surface 4312. Furthermore, the component body 431 can include a plurality of third protruding structures 4331 extending from the first surface 4311 and a plurality of fourth protruding structures 4332 extending from the second surface 4312. In practice, the third protruding structures 4331 and the fourth protruding structures 4332 can be integrally formed on the component body 431. Therefore, the third protruding structures 4331 and the fourth protruding structures 4332 have conductivity. The shapes of the third protruding structures 4331 and the fourth protruding structures 4332 may be rectangular shapes, I-shapes or arc shapes. Furthermore, the third protruding structures 4331 and the fourth protruding structures 4332 are corresponding to the first grounding terminals 4212 and the second grounding terminals 4222 respectively. When the connector structure 4 is assembled, the component body 431 has conductivity, and the first grounding terminal 4212 and the second grounding terminal 4222 can be connected in series by contacting the third protruding structures 4331 and the fourth protruding structures 4332 respectively.

Please refer to FIG. 10. FIG. 10 is a schematic diagram illustrating the assembly of the first grounding terminal 5212, the second grounding terminal 5222 and the grounding component 53 according to an embodiment of the present invention. The difference between this embodiment and the aforementioned embodiment is that first grounding terminal 5212 and the second grounding terminal 5222 have a bulge portion 5213, 5223 respectively. When the connector structure is assembled, each bulge portion 5213, 5223 of the first grounding terminals 5212 and the second grounding terminals 5222 contacts the component body 531 to connect the first grounding terminals 5212 and the second grounding terminals 5222 in series.

In summary, the connector structure of the present invention can connect the grounding terminals of the terminal set in series according to the graphene layer configured on the grounding component to form the grounded shield effect. In addition, the connector structure can reduce the weight of the connector by the non-conductive component body, thereby increasing the convenience and reducing the costs of products.

With the examples and explanations mentioned above, the features and spirits of the invention are hopefully well described. More importantly, the present invention is not limited to the embodiment described herein. Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A connector structure, comprising:
an insulating case;
a terminal set, configured in the insulating case, the terminal set further comprising a first terminal set, the first terminal set comprising a plurality of first grounding terminal; and
a grounding component, configured in the insulating case, the grounding component comprising a component body formed of a graphene material and a non-conductive material;
wherein, the first grounding terminals are connected in series by contacting the grounding component.

2. The connector structure of claim 1, wherein the graphene material forms a graphene layer configured on a surface of the component body by coating.

3. The connector structure of claim 2, wherein the grounding component further comprises a plurality of protruding structure extending from the surface of the component body, the graphene layer is configured on the surface and the protruding structures, the first grounding terminals are connected in series by contacting the protruding structures.

4. The connector structure of claim 3, wherein the arrangement of the protruding structures is corresponding to that of the first grounding terminals.

5. The connector structure of claim 3, wherein the shapes of the protruding structures are selected from one of rectangular, I shape and arc shape.

6. The connector structure of claim 2, wherein the first grounding terminals have a bulge portion respectively, and the bulge portion are contacted the graphene layer of the grounding component to connect the first grounding terminals in series.

7. The connector structure of claim 2, wherein the terminal set further comprises a second terminal set, the second terminal set comprises a plurality of second grounding terminal, the second grounding terminals are contacted the graphene layer to connect the first grounding terminals and the second grounding terminals in series.

8. The connector structure of claim 7, wherein the grounding component is configured between the first terminal set and the second terminal set, and the component body further comprises a first surface, a second surface and a third surface, the third surface is adjacent to the first surface and the second surface, and the graphene layer is configured on the first surface, second surface and the third surface, the first grounding terminals and the second grounding terminals are contacted to the graphene layer of the first surface and the second surface respectively and connected in series through the graphene layer of the third surface.

9. The connector structure of claim 8, wherein the grounding component further comprises a plurality of first protruding structure extending from the first surface of the component body and a plurality of second protruding structure extending from the second surface of the component body, the graphene layer is configured on the first protruding structures and the second protruding structures, the first grounding terminals and the second grounding terminals are connected in series by contacting the first protruding structures and the second protruding structures respectively.

10. The connector structure of claim 1, wherein the non-conductive material and the graphene material forms the component body by injection molding.

11. The connector structure of claim 10, wherein the grounding component further comprises a plurality of third protruding structure extending from a first surface of the component body, the first grounding terminals are connected in series by contacting the third protruding structures.

12. The connector structure of claim 10, wherein the first grounding terminals have a bulge portion respectively, and the bulge portion are contacted the component body to connect the first grounding terminals in series.

13. The connector structure of claim 11, wherein the terminal set further comprises a second terminal set, the second terminal set comprises a plurality of second grounding terminal, the second grounding terminals are contacted component body to connect the first grounding terminals and the second grounding terminals in series.

14. The connector structure of claim 13, wherein the grounding component further comprises a plurality of fourth protruding structure extending from a second surface of the component body, the second surface is opposite to the first surface, the first grounding terminals and the second grounding terminals are connected in series by contacting the third protruding structures and the fourth protruding structures respectively.

15. The connector structure of claim 1, wherein the shape of the grounding component is selected from one of sheet, rectangular and U shape.
